(19) United States
(12) Patent Application Publication
(10) Pub. No.: US 2024/0306106 A1
(43) Pub. Date: Sep. 12, 2024

(54) TIMING ALIGNMENT FOR INTER-UE CROSS-LINK INTERFERENCE MITIGATION IN SUB-BAND FULL-DUPLEX CELLULAR SYSTEMS

(71) Applicant: MediaTek Singapore Pte. Ltd., Singapore (SG)

(72) Inventors: Rama Kiran, Bengaluru KA (IN); Jinesh Parameshwaran Nair, Bengaluru KA (IN); Chien-Hua Chen, Hsinchu (TW); Yih-Shen Chen, Hsinchu (TW); Chandrasekaran Mohandoss, Bengaluru KA (IN); Visanakarra Goraknath Guptha, Bengaluru KA (IN)

(21) Appl. No.: 18/592,835

(22) Filed: Mar. 1, 2024

(30) Foreign Application Priority Data
Mar. 9, 2023 (IN) 202321015796

(51) Int. Cl. H04W 56/00; H04L 5/14

(52) U.S. Cl. CPC H04W 56/0045; H04L 5/14

(57) ABSTRACT

In an aspect of the disclosure, a method, a computer-readable medium, and an apparatus are provided. The method may be performed by a UE. In certain configurations, the UE receives, from a base station, a configuration instruction for enabling a subband full duplex (SBFD) timing alignment (TA) mechanism and a constant c. The UE enables the SBFD TA mechanism according to the configuration instruction. The UE receives, from the base station, a timing adjustment command, which includes a propagation delay δᵢ for the UE. The UE determines whether an uplink (UL) transmission is to be performed in a SBFD slot. In response to determining the UL transmission to be performed in the SBFD slot, the UE applies a timing alignment delay to the UL transmission with respect to the SBFD slot start boundary. The timing alignment delay is determined by both the constant c and the propagation delay δᵢ.

### CROSS-REFERENCE TO RELATED APPLICATION(S)

This application claims the benefits of Indian Provisional Application Ser. No. 202321015796, entitled “TIMING ALIGNMENT FOR INTER-UE CROSS-LINK INTERFERENCE MITIGATION IN SUB-BAND FULL-DUPLEX CELLULAR SYSTEMS” and filed on Mar. 9, 2023, which is expressly incorporated by reference herein in their entirety.

### BACKGROUND

### Field

The present disclosure relates generally to communication systems, and more particularly, to techniques of methods and apparatuses for performing timing alignment for inter-UE cross-link interference mitigation in Subband Full Duplex (SBFD) cellular systems.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a UE. In certain configurations, the UE receives, from a base station, a configuration instruction for enabling a subband full duplex (SBFD) timing alignment (TA) mechanism and a constant c. The UE enables the SBFD TA mechanism according to the configuration instruction. The UE receives, from the base station, a timing adjustment command, wherein the timing adjustment command includes a propagation delay δᵢ for the UE. The UE determines whether an uplink (UL) transmission is to be performed in a SBFD slot. In response to determining the UL transmission to be performed in the SBFD slot, the UE applies a timing alignment delay to the UL transmission with respect to a start boundary of the SBFD slot estimated from previous downlink (DL) receptions. The timing alignment delay is determined by both the constant c and the propagation delay δᵢ. In certain embodiments, the timing alignment delay is determined as 2×(c−δᵢ).

In another aspect of the disclosure, a method, a computer-readable medium, and an apparatus are provided. The method may be performed by a base station. In certain configurations, the base station transmits, to each of a plurality of UEs, a configuration instruction for enabling the UEs with a SBFD TA mechanism. The base station estimates a propagation delay δᵢ for each of the UEs. The base station transmits a timing adjustment command to each of the UEs, and the timing adjustment command to each of the UEs includes the propagation delay δ₁ for each of the UEs.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example cellular system of a base station and a plurality of UEs.

FIG. 8 is a diagram illustrating an example UL timing alignment configure procedure between a UE and a base station.

FIG. 9 is a flow chart of a process of a base station configuring the UEs with the SBFD TA mechanism.

FIG. 10 is a flow chart of a process of a UE being configured with the SBFD TA mechanism.

FIG. 11 is a diagram illustrating the timing advancement to the UL transmission in an uplink-only slot.

FIG. 12 is a diagram illustrating the timing advancement to the UL transmission in a SBFD slot without the SBFD TA mechanism.

FIG. 13 is a diagram illustrating the inter-UE CLI without the SBFD TA mechanism.

FIG. 14 is a diagram illustrating the timing alignment delay to the UL transmission in a SBFD slot.

FIG. 15 is a diagram illustrating the inter-UE CLI with the SBFD TA mechanism.

FIG. 16 is a diagram illustrating the UL transmission start time and the DL arrival time as a function of distance from the base station.

FIG. 17 is a diagram showing the FFT window in DL decoding at a victim UE.

FIG. 18 is a diagram illustrating the timing alignment of the UL transmissions received by the base station from the UEs in the SBFD slots.

FIG. 19 is a flow chart of a method (process) for wireless communication of a UE.

FIG. 20 is a flow chart of a method (process) for wireless communication of a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

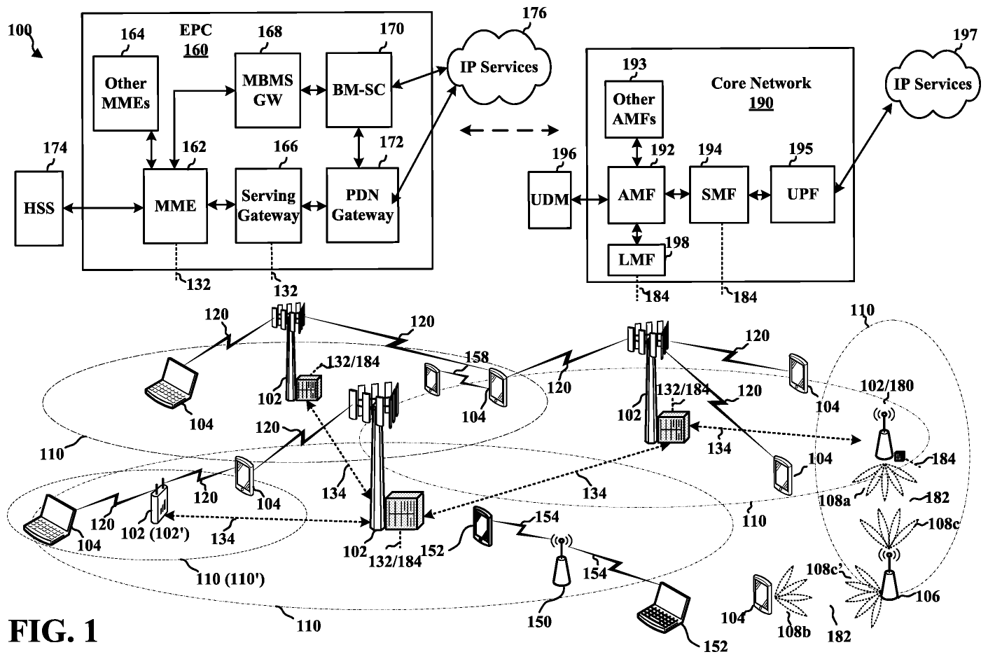

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

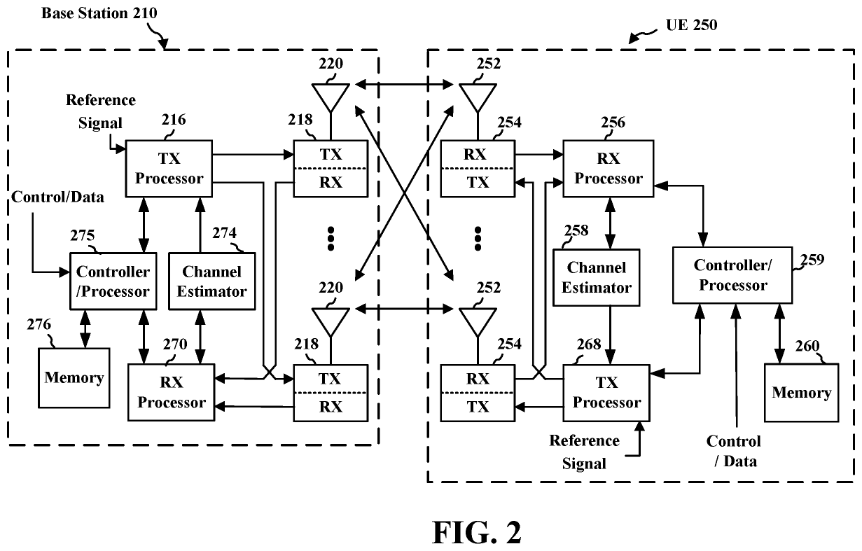

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate mapping matching, onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

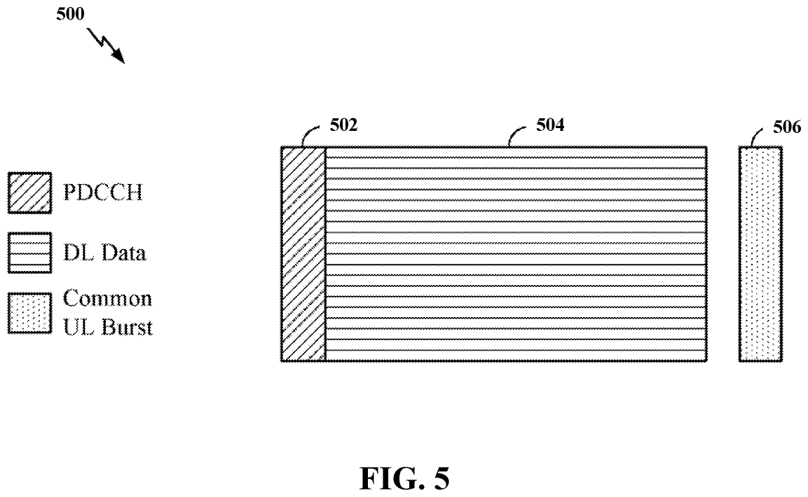

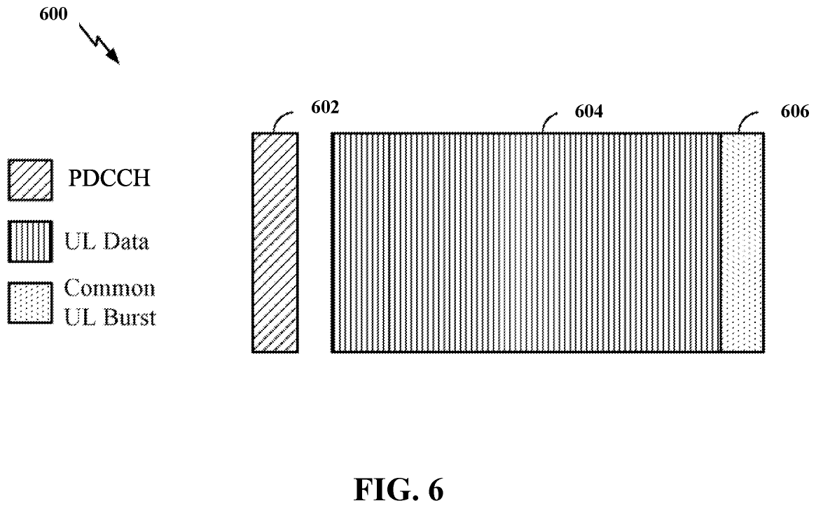

A single component carrier bandwidth of 100 MHz may be supported. In one example, NR resource blocks (RBs) may span 12 sub-carriers with a subcarrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

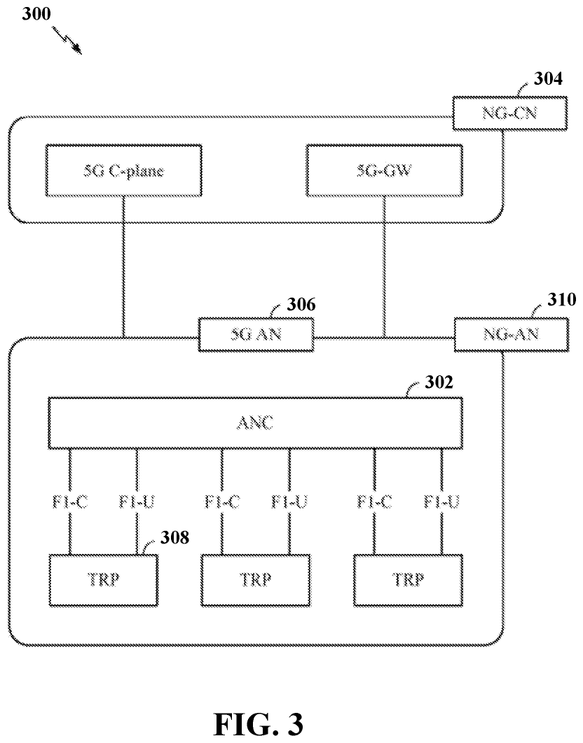

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

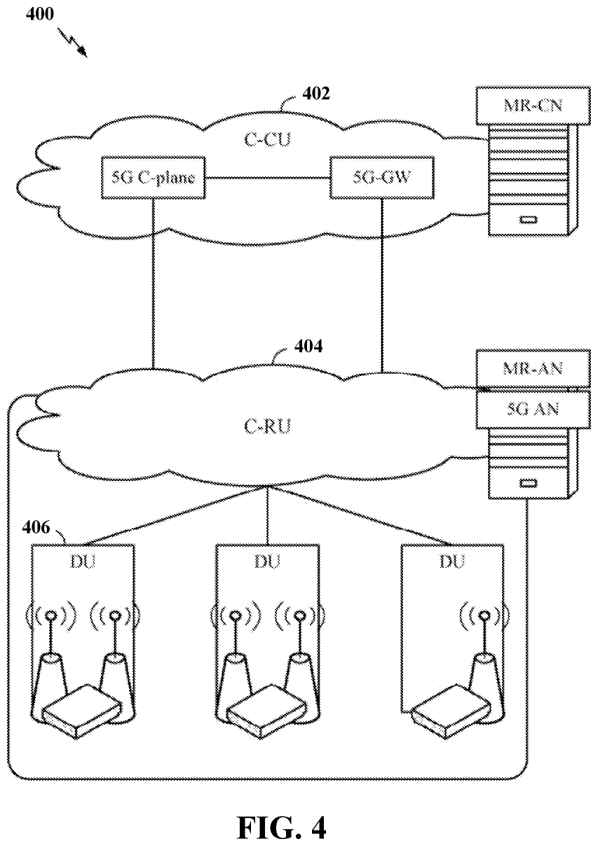

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

TDD is widely used channel access technology in the 5G cellular communication deployments. TDD deployment is based on the half duplex channel access, where the entire component carrier bandwidth is used for either downlink or uplink in a slot. Though many TDD slot formats (which define the DL and UL ratio) are supported by the NR specification, a fixed DL heavy TDD slot format (e.g., DDDSU) is generally preferred in the deployments. In a DL heavy TDD slot format, allocation of a limited time duration for the uplink would result in reduced coverage and increased latency. As an enhancement, the simultaneous existence of downlink and uplink or, more specifically, SBFD operation at the gNB side within a TDD band is introduced in 3GPP Release 18.

SBFD introduces simultaneous UL transmissions in a part of channel bandwidth (CBW) in some DL-only slots of a legacy TDD frame. These slots where UL transmissions coexist with DL transmissions is called as SBFD slots. Therefore, in a SBFD system, three slot types are possible, including: (1) the DL-only slot (generally denoted by D), in which the frequency resources of the slot are available only for DL transmissions; (2) the UL-only slot (generally denoted by U), in which the frequency resources of the slot are available only for UL transmissions; and (3) the SBFD slots (generally denoted by X), in which frequency resources of the slot are available for both DL and UL transmissions. In the SBFD slots, the DL and UL sub-bands are separated by a constant number resource block (RB), which may be referred to as guard band (GB) RBs. The GB RBs are not considered for any DL/UL data transmission.

Currently, there are two slot structures possible in a SBFD slot, including a DUD structure and a DU structure. In the DUD slot structure, the CBW is divided into three parts in the SBFD slots, and the UL signal is transmitted in the central part. In the DU slot structure, the UL signal is transmitted in the bottom part of the CBW.

In the SBFD slots, proximity of the UL and DL transmission sub-bands cause sever inter-UE CLI/SI at DL UEs operating in the DL sub-bands due to inter-band power leakages. Note that SI along with inter-UE CLI occurs when the UEs are also SBFD-capable and they transmit in UL and DL directions simultaneously. These power leakages or interferences are due to transmitter and receiver impairments such as power amplifier nonlinearities and imperfections in digital to analog converters. To achieve an efficient communication, inter-UE CLI/SI needs to be suppressed to a negligible level below the noise floor. For the inter-UE CLI/SI suppression, interference mitigation techniques such as using guard band between UL and DL sub-bands, null beamforming in the direction of downlink receiver, and transmitter side filtering etc. are studied in the literature. However, the severity of these interferences creates further scope for exploring new avenues.

In view of the issues, certain aspects of the disclosure relate to a modified uplink timing alignment (TA) procedure, in which the base station (e.g., gNB) may enable the UEs with a SBFD TA mechanism for performing TA for inter-UE cross-link interference mitigation. In certain configurations, the modified uplink TA procedure may be used in the legacy TDD systems for inter-UE CLI/SI reduction.

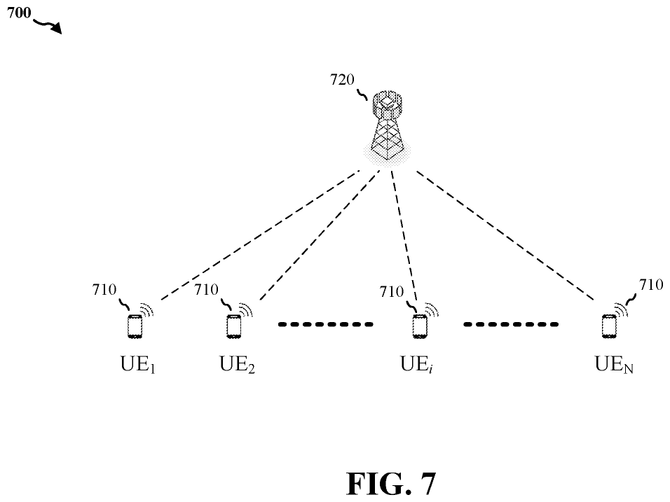

FIG. 7 is a diagram illustrating an example cellular system of a base station and a plurality of UEs. As shown in FIG. 7, the cellular system 700 includes a plurality of UEs 710 and a base station 720. Specifically, the system 700 includes a total of N UEs 710, and each UE 710 may be identified as UE i, where i is a positive integer between [1,N]. In certain configurations, the base station 720 may configure the UEs 710 to enable a SBFD TA mechanism with corresponding parameters, allowing the base station 720 to receive the uplink transmissions from the UEs 710 in the corresponding SBFD slots to the base station 720 in synchronization. On the other hand, if one of the UEs 710 performs the uplink transmission in an uplink-only slot, the legacy TDD UL TA mechanism may be used.

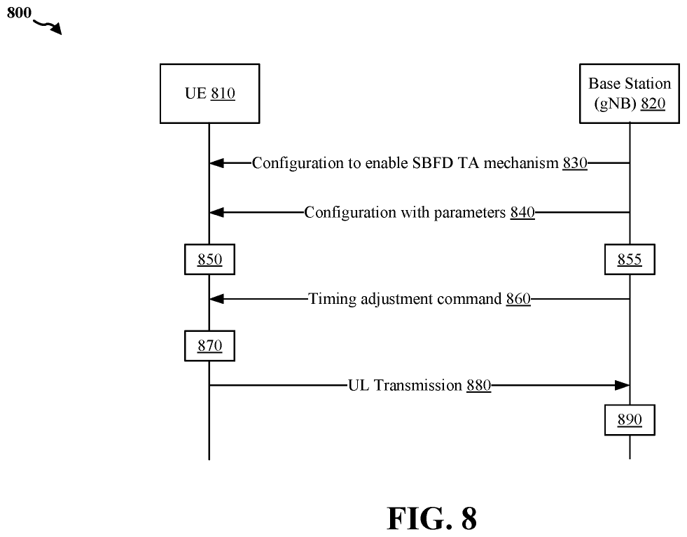

FIG. 8 is a diagram illustrating an example UL timing alignment configure procedure between a UE and a base station. As shown in FIG. 8, at operation 830, the base station 820 (e.g., gNB) may transmit a configuration instruction to the UE 810 to configure the SBFD/TDD frame format, and to indicate the UE 810 to enable the SBFD TA mechanism. At operation 840, the base station 820 may further transmit parameters for configuring the UE 810. Specifically, the parameters may include a constant c and a fixed parameter N_{TA,offset}, which may be used for calculating a timing alignment delay and/or a timing advancement to the UL transmission. At the UE 810 side, upon receiving the configuration instruction and the parameters, at operation 850, the UE 810 configures the SBFD/TDD frame format and enables the SBFD TA mechanism according to the configuration instruction and the parameters. Meanwhile, at operation 855, the base station 820 estimates a propagation delay for the UE 810, where the propagation delay indicates a time taken for a wireless signal to traverse from the UE 810 to the base station 820 or from the base station 820 to the UE 810. Specifically, the cellular system (e.g., the system 700) of the base station 820 may include N UEs, and the base station may estimate a propagation delay di for each UE i in the cellular system. At operation 860, the base station 820 transmits a timing adjustment command to the UE 810, and the timing adjustment command includes the propagation delay δᵢ for the UE 810, allowing the UE 810 to use the propagation delay δᵢ in the SBFD TA mechanism to determine the corresponding timing alignment delay and/or the timing advancement. The transmission of the timing adjustment command may be existing methods such as RRC messaging, downlink control information (DCI) exchange, or MAC control element (MAC CE) messaging.

At operation 870, upon receiving the timing adjustment command, the UE 810 performs a slot check according to the SBFD TA mechanism. Specifically, the UE 810 checks the slot format for the uplink transmission to determine whether the UL transmission is to be performed in a SBFD slot or an uplink-only slot. If the UL transmission is to be performed in the SBFD slot, the UE 810 applies a timing alignment delay to the UL transmission with respect to a start boundary of the SBFD slot, where the timing alignment delay is 2×(c−8ᵢ). On the other hand, if the UL transmission is to be performed in the uplink-only slot and not the SBFD slot, the UE 810 applies a timing advancement to the UL transmission with respect to a start boundary of the uplink-only slot, where the timing advancement is (N_{TA,offset}+2×δᵢ/T_{c})×T_{c}, and T_{c} is a fixed timing value. At operation 880, the UE 810 performs the UL transmission according to the determination of the SBFD TA mechanism correspondingly, with either the timing alignment delay (in the SBFD slot) or the timing advancement (in the uplink-only slot) being applied to the UL transmission. At operation 890, the base station 820 receives the UL transmission from the UE 810.

It should be noted that, with the SBFD TA mechanism being enabled at the UE 810, the base station 820 may receive the UL transmission signals from all of the UEs in the cellular system synchronized at (2×c) after a slot start boundary (i.e., the start of the downlink transmission/SBFD slot) if the slot for the UL transmission from each UE is the SBFD slot. On the other hand, the base station 820 receives the UL transmission signals from all of the UEs in the cellular system synchronized at (N_{TA,offset}×T_{c}) before the slot start boundary if the slot for the UL transmission from each UE is the uplink-only slot.

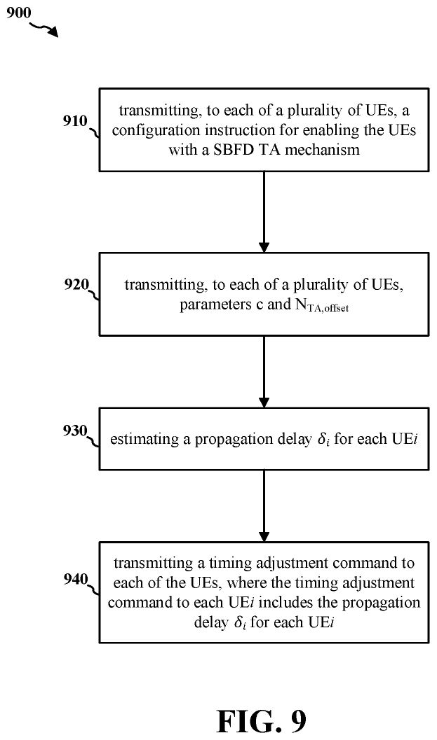

FIG. 9 is a flow chart of a process of a base station configuring the UEs with the SBFD TA mechanism. The process 900 may be performed by a base station (e.g., gNB), which may be the base station 720 or the base station 820. As shown in FIG. 9, at operation 910, the base station transmits, to each of a plurality of UEs, a configuration instruction for enabling the UEs with a SBFD TA mechanism. At operation 920, the base station transmits, to each of a plurality of UEs, the parameters c and N_{TA,offset}. At operation 930, the base station estimates a propagation delay δᵢ for each UE i, where i=[1,N]. At operation 940, the base station transmits a timing adjustment command to each of the UEs, where the timing adjustment command to each UE i includes the propagation delay δᵢ for each UE i.

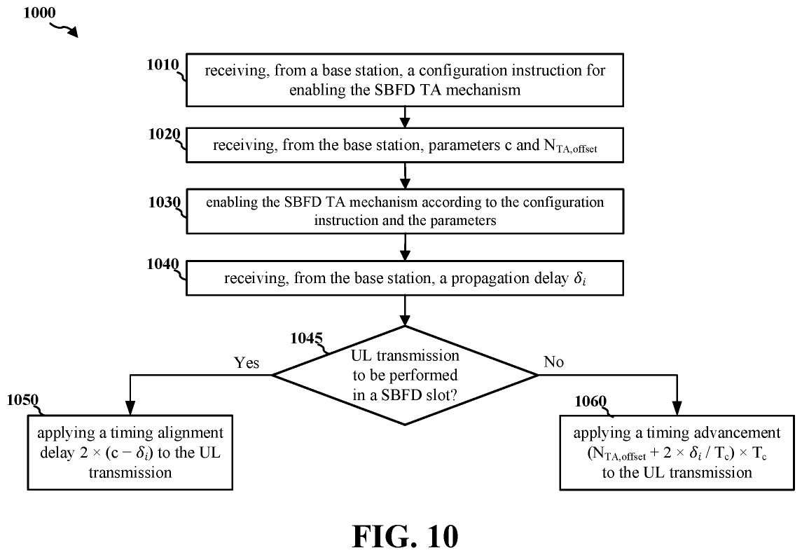

FIG. 10 is a flow chart of a process of a UE being configured with the SBFD TA mechanism. The process 1000 may be performed by a UE, which may be one of the UEs 710 or the UE 810. As shown in FIG. 10, at operation 1010, the UE receives, from a base station (e.g., gNB), a configuration instruction for enabling the SBFD TA mechanism. At operation 1020, the UE receives, from the base station, the parameters c and N_{TA,offset}. At operation 1030, the UE enables the SBFD TA mechanism according to the configuration instruction and the parameters. At operation 1040, the UE receives, from the base station, a timing adjustment command, and the timing adjustment command includes a propagation delay δᵢ for the UE. At operation 1045, the UE determines whether an UL transmission is to be performed in a SBFD slot. If the UE determines the UL transmission to be performed in the SBFD slot, at operation 1050, the UE applies a timing alignment delay of 2×(c−δᵢ) to the UL transmission with respect to the start boundary of the SBFD slot. On the other hand, if the UE determines the UL transmission to be performed in an uplink-only slot and not the SBFD slot, at operation 1060, the UE applies a timing advancement (N_{TA,offset}+2×δᵢ/T_{c})×T_{c} to the UL transmission with respect to the start boundary of the SBFD slot.

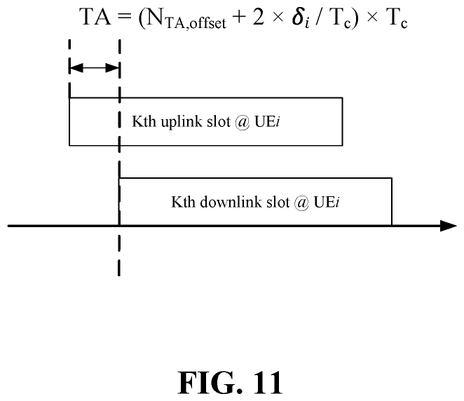

FIG. 11 is a diagram illustrating the timing advancement to the UL transmission in an uplink-only slot. Specifically, the SBFD TA mechanism applies the timing advancement in a similar way to the legacy TDD UL transmission. In particular, when the UL transmission is to be performed in an uplink-only slot, the UE advances its transmission with respect to the corresponding DL slot boundary by a duration (N_{TA,offset}+N_{TA})×T_{c}, where N_{TA,offset} is a constant timing advancement component that is decided by the base station (e.g., gNB), N_{TA} is constant component that depends on the signal propagation delay between the UE and the base station, and T_{c} is a reference time in the 5G NR. In certain configurations, N_{TA,offset} is a fixed value that accounts the time for switching from the receiving mode to the transmission mode at the gNB, N_{TA}=(2×δᵢ)/T_{c}, and T_{c} is 0.509 ns. As shown in FIG. 11, for the kth uplink slot at the UE, the timing alignment is applied to advance the UL transmission with respect to the corresponding kth downlink slot at the UE.

In the SBFD TA mechanism, the timing advancement as shown in FIG. 11 is applied only for the uplink-only slot, and the timing alignment delay is applied for the SBFD slot. In the legacy TDD UL TA mechanism, however, the timing advancement is applied to all slots, including the uplink-only slot and the SBFD slots, thus creating the inter-UE interference problems.

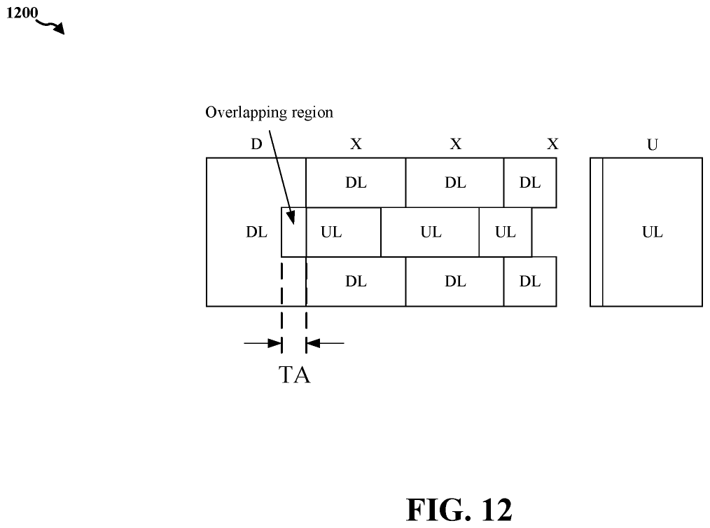

FIG. 12 is a diagram illustrating the timing advancement to the UL transmission in a SBFD slot without the SBFD TA mechanism. Specifically, FIG. 12 shows a DXXXU time domain frame/slot format, in which the SBFD slots (represented by the “X” symbols) follow a DL-only slot (represented by the “D” symbol). In such a frame format, without the SBFD TA mechanism, the legacy TDD UL timing advancement is applied to the SBFD slots without any guard interval between the preceding downlink-only slot, and the UL transmission in the first SBFD slot in the frame will overlap on a part of DL-only slot, creating an overlapping region. This overlapping region will create severe intra-band inter-UE cross-link interference (CLI) to the downlink-only slot of the UE because of the signal collisions. If the UE is a SBFD UE (e.g., a half-duplex UE that can either transmit or receive in the SBFD slot, or a full duplex UE that can simultaneously transmit and receive in a particular SBFD slot) receiving in the DL-only slot and transmitting in the SBFD slot, the CLI will be more severe.

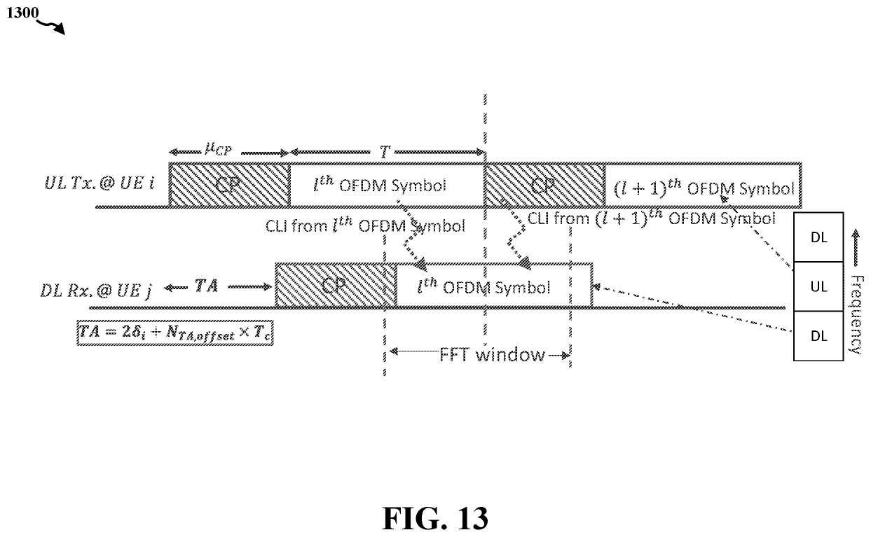

FIG. 13 is a diagram illustrating the inter-UE CLI without the SBFD TA mechanism. Specifically, when two UEs (e.g., the UEs 710 as shown in FIG. 7) are located very close to each other, the propagation delays for the two UEs (e.g., δᵢ for the UE i and δⱼ for the UE j) may be substantially identical (i.e., δᵢⱼ≈0), and the legacy TDD UL timing advancement being applied to a SBFD slot may create severe inter-UE CLI due to inter-carrier interference (ICI), namely, two uplink orthogonal frequency division multiplexed (OFDM) symbols of the aggressor UE (e.g., UE i) interfere with a downlink OFDM symbol at a victim UE (e.g., UE j) as shown in FIG. 13. In particular, the aggressor UE i means an uplink UE that causes the CLI because of uplink transmissions, and the victim UE j is a downlink UE that receives the inter-UE CLI from the aggressor UE i. Since the legacy TDD advances the UL transmission by a duration more than the CP length, the two consecutive OFDM symbols transmitted by the UE i, including the lth and (l+1)th symbols, will interfere at the UE j. This will cause severe CLI to the UE j due to leakages because of ICI at the victim UE's receiver due to loss of orthogonality in interfering OFDM symbols. In another case, if the UE i is SBFD-capable (e.g., full duplex) and it is also receiving signal from the base station (e.g., gNB) in DL direction, then the UL transmitter can create further severe self-interference (SI) at its DL receiver due to the same reasons.

In view of the problems, the SBFD TA mechanism is introduced for inter-UE CLI reduction in the SBFD-aware (e.g., half-duplex) UEs and inter-UE CLI and SI reduction in the SBFD-capable (e.g., full-duplex) UEs. For example, a UE i may be a half-duplex UE, which may only transmit in the UL or DL direction but not both simultaneously, and the UE is SBFD-aware, which may transmit or receive data in a SBFD slot. The SBFD TA mechanism focuses on the SBFD slots. On the other hand, as discussed, the timing advancement in the legacy TDD UL TA mechanism remains being applied for the uplink-only slot, as the uplink-only slot does not experience the inter-UE CLI and SI. This is due to the guard interval after the last DL-only/SBFD slot prevents UL transmission overlap with the previous DL-only/SBFD slot and there is no simultaneous DL transmission within CBW.

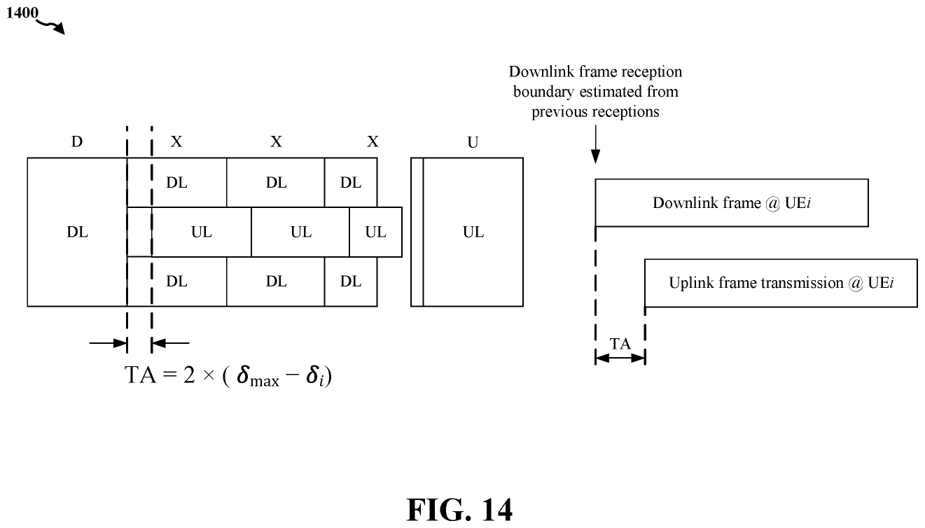

FIG. 14 is a diagram illustrating the timing alignment delay to the UL transmission in a SBFD slot. Specifically, when the SBFD TA mechanism is applied, the base station estimates the propagation delay δᵢ for the UE i, using the existing delay estimation algorithms, where i is a value between 1 to N, and N is the number of UEs connected to the base station. As shown in FIG. 14, the UE i applies timing alignment delay of 2×(c−δᵢ) to the UL transmission in the SBFD slot with respect to the slot start boundary. This timing alignment delay to the UL transmission will align the interfering UL symbol boundaries within the CP of DL receptions. Thus, the timing alignment delay may reduce the SI generated by the UL transmitter of the UE and the inter-UE CLI from the UL transmissions to other DL UEs in the cell.

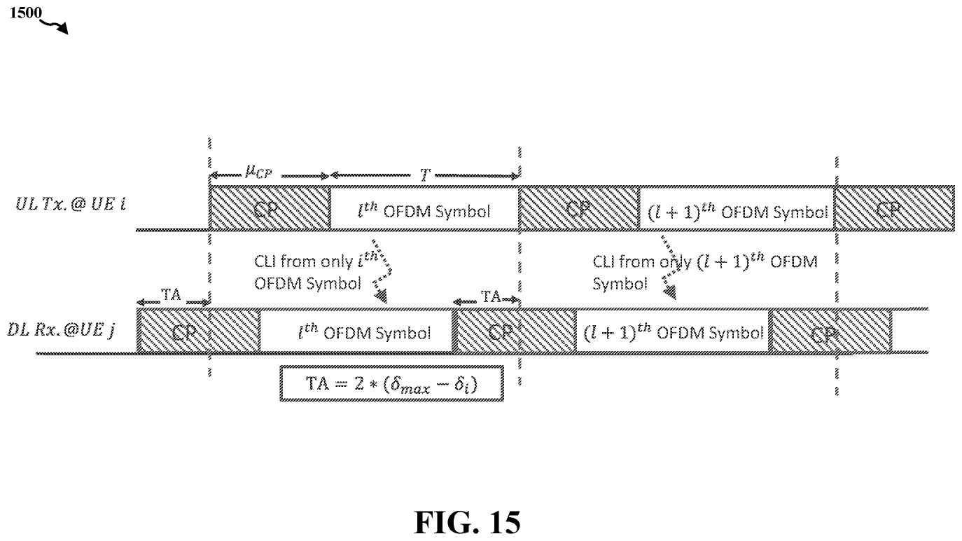

FIG. 15 is a diagram illustrating the reduced inter-UE CLI with the SBFD TA mechanism. As shown in FIG. 15, with the timing alignment delay being applied to the UL transmission, the interfering UL symbol boundaries of the aggressor UE i will be aligned to the CP of the DL transmission of the victim UE j, such that the interference from (1-1)th uplink OFDM symbol falls into the CP of the 1th downlink OFDM symbol. Since the CP is discarded before the DL symbol is decoded, only one UL OFDM symbol transmitted by the aggressor UE i (e.g., the lth UL OFDM symbol) will interfere the corresponding DL transmission at the victim UE j, thus reducing the inter-UE CLI due to orthogonality in the interfering OFDM symbol.

The value of the constant c may be optimized. As discussed, the UL transmission in the first SBFD slot in a frame should not collide with the previous DL transmission in the preceding DL-only slot. For example, in DXXXU frame format as shown in FIG. 14, UL transmissions in the first X slot should not collide with the D slot.

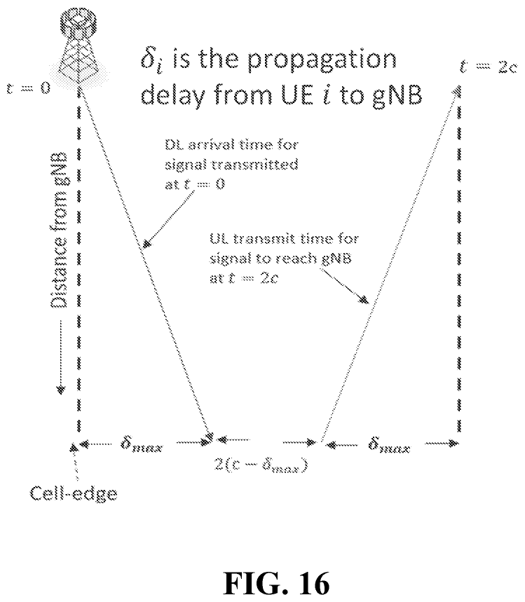

FIG. 16 is a diagram illustrating the UL transmission start time and the DL arrival time as a function of distance from the base station. Specifically, the DL arrival times at the UEs when the signal is transmitted from the base station (e.g., gNB) at t=0 and the UL transmission start boundaries to arrive signals at the base station synchronized at t=2c may be represented as a function of the distance from the base station. As shown in FIG. 16, the time duration between the uplink transmission and previous DL transmission end boundary is minimum when the UE is at the cell-edge. Therefore, to avoid collisions with DL-only slot, this minimum value should be greater than zero, i.e., 2×(c−δₘₐₓ)≥0, or c≥δₘₐₓ.

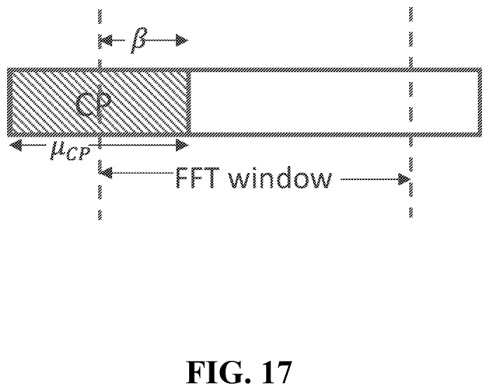

FIG. 17 is a diagram showing the FFT window in DL decoding at a victim UE. Specifically, as shown in FIG. 17, another parameter that needs to be considered while designing value of c is the FFT decoding window advancement margin β, which allows to have the start of FFT decoding window before the CP end boundary. Advancing the FFT decoding window with the margin β has benefits when there is an error in the start of symbol time estimation. Since a UE located near the base station has negligible or zero propagation delay, such UE may transmit uplink signal with timing advancement of 2×(c−0). To avoid leakage due to ICI, this uplink transmission start boundary should not fall within the FFT window of DL reception. Thus, the UL transmissions from the UEs should arrive by duration β before the CP end boundary, and the constant c must meet the condition 2c<μ_{CP}−β or β<μ_{CP}−2c. Therefore, the FFT window advancement margin β will reduce with the value of c. Accordingly, to optimize the value of the margin β, the constant c may be determined as c=δₘₐₓ, and the timing alignment delay is thus determined as 2×(δₘₐₓ−δᵢ).

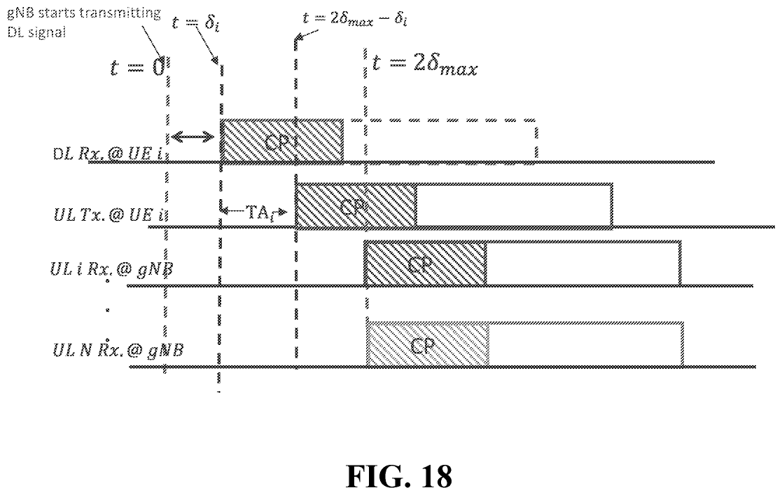

FIG. 18 is a diagram illustrating the timing alignment of the UL transmissions received by the base station from the UEs in the SBFD slots. Specifically, with the SBFD TA mechanism being applied to the UEs, at the base station (e.g., gNB), in the SBFD slots, all UL transmissions arrive at the gNB may be synchronized at time (2×c) after the SBFD slot start boundary.

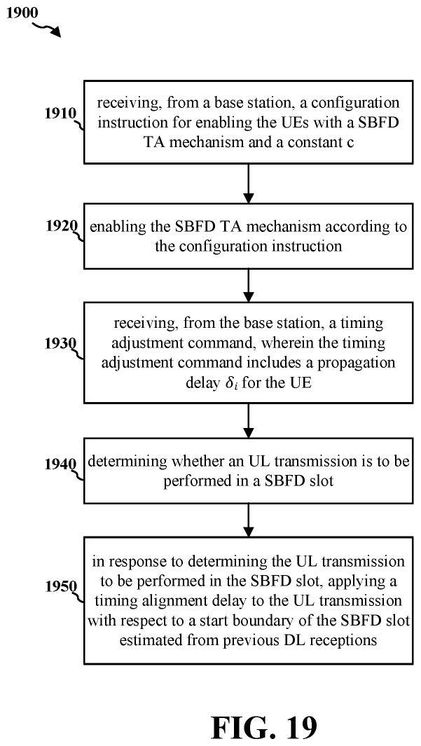

FIG. 19 is a flow chart of a method (process) for wireless communication of a UE. The method may be performed by a UE (e.g., UE 710 or 810). At operation 1910, the UE receives, from a base station, a configuration instruction for enabling a SBFD TA mechanism and a constant c. At operation 1920, the UE enables the SBFD TA mechanism according to the configuration instruction. At operation 1930, the UE receives, from the base station, a timing adjustment command, wherein the timing adjustment command includes a propagation delay δᵢ for the UE. At operation 1940, the UE determines whether an UL transmission is to be performed in a SBFD slot. At operation 1950, in response to determining the UL transmission to be performed in the SBFD slot, the UE applies a timing alignment delay to the UL transmission with respect to a start boundary of the SBFD slot from previous DL receptions. The timing alignment delay is determined by both the constant c and the propagation delay δᵢ. In certain embodiments, the timing alignment delay is determined as 2×(c−δᵢ). Optionally, in response to determining the UL transmission to be performed in an uplink-only slot and not the SBFD slot, the UE applies a timing advancement to the UL transmission from the previous DL slot. The configuration instruction further includes a fixed parameter N_{TA,offset}, and the timing advancement is determined by the fixed parameter N_{TA,offset}, the propagation delay δᵢ and a fixed timing value T_{c}. In certain embodiments, the timing advancement is determined as (N_{TA,offset}+2×δᵢ/T_{c})×T_{c}.

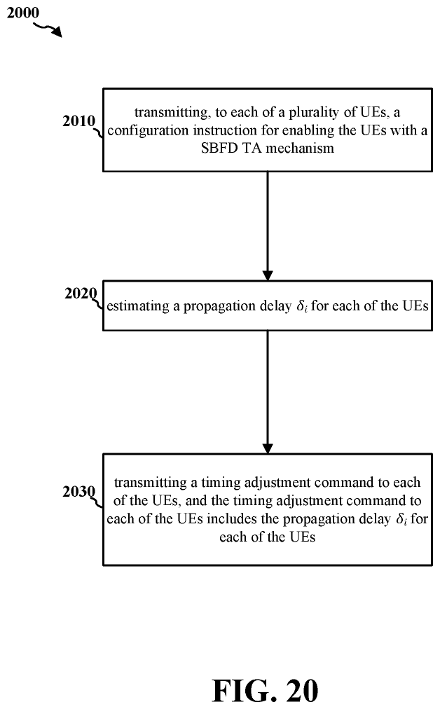

FIG. 20 is a flow chart of a method (process) for wireless communication of a base station. The method may be performed by a base station (e.g., gNB). At operation 2010, the base station transmits, to each of a plurality of UEs, a configuration instruction for enabling the UEs with a SBFD TA mechanism. At operation 2020, the base station estimates a propagation delay δᵢ for each of the UEs. At operation 2030, the base station transmits a timing adjustment command to each of the UEs, and the timing adjustment command to each of the UEs includes the propagation delay δᵢ for each of the UEs. Optionally, the base station receives, from a specific UE of the UEs, an UL transmission. In certain embodiments, the UL transmission is performed by the specific UE in a SBFD slot, and the UL transmission is received at (2×c) after a slot start boundary, where c is a constant. Alternatively, in certain embodiments, the UL transmission is performed by the specific UE in an uplink-only slot, and the UL transmission is received at (N_{TA,offset}×T_{c}) before the slot start boundary, wherein N_{TA,offset}, is a fixed parameter, and T_{c} is a fixed timing value.

In certain configurations, the constant c=δₘₐₓ, where δₘₐₓ may be a minimum value for delaying a UL transmission in a SBFD slot to avoid collision with a downlink-only slot, and δₘₐₓ is a maximum propagation delay in a cell of the UE. In one embodiment, δₘₐₓ=(ISD/2)/(3×10⁸), where ISD is the inter-site distance.

In certain configurations, the constant c may be an optimum value for optimizing a receiving fast Fourier transform (FFT) window advancement margin, where c=δₘₐₓ, and δₘₐₓ is a maximum propagation delay in a cellular system of the base station.

In certain embodiments, the first pre-MG has an initial pre-configured delay, and the pre-MG activation procedure is determined to collide with or to be overlapped with the overlapping gap based on an end of the initial pre-configured delay.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving, from a base station, a configuration instruction for enabling a subband full duplex (SBFD) timing alignment (TA) mechanism and a constant c;
enabling the SBFD TA mechanism according to the configuration instruction;
receiving, from the base station, a timing adjustment command, wherein the timing adjustment command includes a propagation delay δᵢ for the UE;
determining whether an uplink (UL) transmission is to be performed in a SBFD slot; and
in response to determining the UL transmission to be performed in the SBFD slot, applying a timing alignment delay to the UL transmission with respect to a start boundary of the SBFD slot estimated from previous downlink (DL) receptions,
wherein the timing alignment delay is determined by both the constant c and the propagation delay δᵢ.

2. The method of claim 1, wherein the timing alignment delay is determined as 2×(c−δᵢ).

3. The method of claim 1, further comprising:
in response to determining the UL transmission to be performed in an uplink-only slot and not the SBFD slot, applying a timing advancement to the UL transmission with respect to a start boundary of the uplink-only slot estimated from the previous DL receptions,
wherein the configuration instruction further includes a fixed parameter N_{TA,offset}, and the timing advancement is determined by the fixed parameter N_{TA,offset}, the propagation delay δᵢ and a fixed timing value T_{c}.

4. The method of claim 3, wherein the timing advancement is determined as (N_{TA,offset}+2×δᵢ/T_{c})×T_{c}.

5. The method of claim 1, wherein the constant c=δₘₐₓ, wherein δₘₐₓ is a minimum value of the constant c for delaying the UL transmission in the SBFD slot to avoid collision with a DL only slot, and δₘₐₓ is a maximum propagation delay in a cell of the UE.

6. The method of claim 1, wherein the constant c is an optimum value for optimizing a receiving fast Fourier transform (FFT) window advancement margin, wherein c=δₘₐₓ, and δₘₐₓ is a maximum propagation delay in a cellular system of the base station.

7. A method of wireless communication of a base station, comprising:
transmitting, to each of a plurality of user equipments (UEs), a configuration instruction for enabling the UEs with a subband full duplex (SBFD) timing alignment (TA) mechanism;
estimating a propagation delay δᵢ for each of the UEs; and
transmitting a timing adjustment command to each of the UEs, wherein the timing adjustment command to each of the UEs includes the propagation delay δᵢ for each of the UEs.

8. The method of claim 7, wherein the propagation delay δᵢ for each of the UEs indicates a time taken for a wireless signal to traverse from the each of the UEs to the base station or from the base station to the each of the UEs.

9. The method of claim 7, further comprising:
receiving, from a specific UE of the UEs, an uplink (UL) transmission, wherein
the UL transmission is performed by the specific UE in a SBFD slot, and the UL transmission is received at (2×c) after a slot start boundary, wherein c is a constant; or
the UL transmission is performed by the specific UE in an uplink-only slot, and the UL transmission is received at (N_{TA,offset}×T_{c}) before the slot start boundary, wherein N_{TA,offset}, is a fixed parameter, and T_{c} is a fixed timing value.

10. The method of claim 9, wherein the constant c=δₘₐₓ, wherein δₘₐₓ is a minimum value of the constant c for delaying a UL transmission in a SBFD slot to avoid collision with a downlink-only slot, and δₘₐₓ is a maximum propagation delay in a cell of the UE.

11. The method of claim 9, wherein the constant c is an optimum value for optimizing a receiving fast Fourier transform (FFT) window advancement margin, wherein c=δₘₐₓ, and δₘₐₓ is a maximum propagation delay in a cellular system of the base station.

12. An apparatus for wireless communication, the apparatus being a user equipment (UE), comprising:
a memory; and
at least one processor coupled to the memory and configured to:
receive, from a base station, a configuration instruction for enabling a subband full duplex (SBFD) timing alignment (TA) mechanism and a constant c;
enable the SBFD TA mechanism according to the configuration instruction;
receive, from the base station, a timing adjustment command, wherein the timing adjustment command includes a propagation delay δᵢ for the UE;
determine whether an uplink (UL) transmission is to be performed in a SBFD slot; and
in response to determining the UL transmission to be performed in the SBFD slot, apply a timing alignment delay to the UL transmission with respect to a start boundary of the SBFD slot estimated from previous downlink (DL) receptions,
wherein the timing alignment delay is determined by both the constant c and the propagation delay δᵢ.

13. The apparatus of claim 12, wherein the timing alignment delay is determined as 2×(c−δᵢ).

14. The apparatus of claim 12, wherein the processor is further configured to:
in response to determining the UL transmission to be performed in an uplink-only slot and not the SBFD slot, apply a timing advancement to the UL transmission with respect to a start boundary of the uplink-only slot estimated from the previous DL receptions,
wherein the configuration instruction further includes a fixed parameter N_{TA,offset}, and the timing advancement is determined by the fixed parameter N_{TA,offset}, the propagation delay δᵢ and a fixed timing value T_{c}.

15. The apparatus of claim 14, wherein the timing advancement is determined as (N_{TA,offset}+2×δᵢ/T_{c})×T_{c}.

16. The apparatus of claim 12, wherein the constant c=δₘₐₓ, wherein δₘₐₓ is a minimum value of the constant c for delaying the UL transmission in the SBFD slot to avoid collision with a DL only slot, and δₘₐₓ is a maximum propagation delay in a cell of the UE.

17. The apparatus of claim 12, wherein the constant c is an optimum value for optimizing a receiving fast Fourier transform (FFT) window advancement margin, wherein c=δₘₐₓ, and δₘₐₓ is a maximum propagation delay in a cellular system of the base station.

18. An apparatus for wireless communication, the apparatus being a base station, comprising:
a memory; and
at least one processor coupled to the memory and configured to:
transmit, to each of a plurality of user equipments (UEs), a configuration instruction for enabling the UEs with a subband full duplex (SBFD) timing alignment (TA) mechanism;
estimate a propagation delay di for each of the UEs; and
transmit a timing adjustment command to each of the UEs, wherein the timing adjustment command to each of the UEs includes the propagation delay di for each of the UEs.

19. The apparatus of claim 18, wherein the processor is further configured to:
receive, from a specific UE of the UEs, an uplink (UL) transmission, wherein
the UL transmission is performed by the specific UE in a SBFD slot, and the UL transmission is received at (2×c) after a SBFD slot start boundary, wherein c is a constant; or
the UL transmission is performed by the specific UE in an uplink-only slot, and the UL transmission is received at (N_{TA,offset}×T_{c}) before the slot start boundary, wherein N_{TA,offset}, is a fixed parameter, and T_{c} is a fixed timing value.

20. The apparatus of claim 18, wherein the constant c is an optimum value for optimizing a receiving fast Fourier transform (FFT) window advancement margin, wherein c=δₘₐₓ, and δₘₐₓ is a maximum propagation delay in a cellular system of the base station.
